(19) United States
(12) Patent Application Publication
(10) Pub. No.: US 2023/0262825 A1
(43) Pub. Date: Aug. 17, 2023

(54) METHOD AND APPARATUS FOR THE CONDITIONAL PSCELL CHANGE IN NEXT GENERATION MOBILE COMMUNICATION SYSTEM

(71) Applicant: Samsung Electronics Co., Ltd., Suwon-si (KR)

(72) Inventor: June HWANG, Suwon-si (KR)

(21) Appl. No.: 18/170,209

(22) Filed: Feb. 16, 2023

(30) Foreign Application Priority Data
Feb. 17, 2022 (KR) 10-2022-0021095

(51) Int. Cl. H04W 76/20; H04W 76/30

(52) U.S. Cl. CPC H04W 76/20; H04W 76/30

(57) ABSTRACT

The disclosure relates to a 5^{th} generation (5G) or 6^{th} generation (6G) communication system for supporting a higher data transmission rate. A method and an apparatus for conditional primary secondary cell group (SCG) (PS)cell change in a next generation mobile communication system are provided. According to an embodiment of the disclosure, a method performed by a user equipment (UE) in a wireless communication system is provided. The method includes receiving radio resource control (RRC) reconfiguration message including conditional reconfiguration information, performing a conditional reconfiguration procedure based on first variable related to the MN, and performing the conditional reconfiguration procedure based on second variable related to the SN.

### CROSS-REFERENCE TO RELATED APPLICATION(S)

This application is based on and claims priority under 35 U.S.C. § 119(a) of a Korean patent application number 10-2022-0021095, filed on Feb. 17, 2022, in the Korean Intellectual Property Office, the disclosure of which is incorporated by reference herein in its entirety.

### BACKGROUND

### 1. Field

The disclosure relates to a next generation mobile communication system. More particularly, the disclosure relates to an intra-secondary node (SN) and inter-SN simultaneous operation, in a conditional primary secondary cell group (SCG) (PS) cell change (CPC) of a user equipment (UE).

### 2. Description of Related Art

Generally, 5^{th} generation (5G) mobile communication technologies define broad frequency bands such that high transmission rates and new services are possible, and may be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

Additionally, at the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). Additionally, there also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

Further, as 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, drone communication, and the like.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for conditional primary secondary cell group (SCG) (PS)cell change in a next generation mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving radio resource control (RRC) reconfiguration message including conditional reconfiguration information, in case that the conditional reconfiguration information is first conditional reconfiguration information related with master cell group (MCG) and the RRC reconfiguration message is received via a signaling radio bearer 1 (SRB1) from a master node (MN), performing a conditional reconfiguration procedure based on first variable related to the MN, and in case that the conditional reconfiguration information is second conditional reconfiguration information related with secondary cell group (SCG), and the RRC reconfiguration is first RRC reconfiguration message embedded in second RRC reconfiguration message and the second RRC reconfiguration message is received via the SRB1 from the MN or the RRC reconfiguration message is received via a SRB3 from a secondary node (SN), performing the conditional reconfiguration procedure based on second variable related to the SN.

In accordance with another aspect of the disclosure, a user equipment (UE) in a wireless communication system is provided. The UE includes a transceiver and at least one controller operably coupled to the transceiver, the at least one controller configured to receive radio resource control (RRC) reconfiguration message including conditional reconfiguration information, in case that the conditional reconfiguration information is first conditional reconfiguration information related with master cell group (MCG) and the RRC reconfiguration message is received via a signaling radio bearer 1 (SRB1) from a master node (MN), perform a conditional reconfiguration procedure based on first variable related to the MN, and in case that the conditional reconfiguration information is second conditional reconfiguration information related with secondary cell group (SCG), and the RRC reconfiguration is first RRC reconfiguration message embedded in second RRC reconfiguration message and the second RRC reconfiguration message is received via the SRB1 from the MN or the RRC reconfiguration message is received via a SRB3 from a secondary node (SN), perform the conditional reconfiguration procedure based on second variable related to the SN.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a long term evolution (LTE) system structure according to an embodiment of the disclosure;

FIG. 2 is a diagram illustrating a radio protocol structure of an LTE system according to an embodiment of the disclosure;

FIG. 3 is a diagram illustrating a next generation mobile communication system structure according to an embodiment of the disclosure;

FIG. 4 is a diagram illustrating a radio protocol structure of a next generation mobile communication system according to an embodiment of the disclosure;

FIG. 5 is a block diagram illustrating an internal structure of a terminal according to an embodiment of the disclosure;

FIG. 6 is a block diagram illustrating a configuration of a new radio (NR) base station according to an embodiment of the disclosure; and

FIG. 7 is a diagram illustrating a method for allocating a conditional primary secondary cell group (SCG) (PS) cell change (CPC) configuration identifier (ID) at a main node (MN), if providing intra-secondary node (SN) CPC configuration to a terminal according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some components in the accompanying drawings are exaggerated, omitted, or schematically illustrated. Also, a size of each component does not entirely reflect an actual size. The same reference number is given to the same or corresponding element in each drawing.

Advantages and features of the disclosure, and methods for achieving them will be clarified with reference to embodiments described below in detail together with the accompanying drawings. The disclosure is not limited to the embodiments disclosed below but may be implemented in various different forms, the embodiments are provided to only complete the scope of the disclosure and to allow those skilled in the art to which the disclosure pertains to fully understand a category of the disclosure, and the disclosure is solely defined within the scope of the claims. The same reference numeral refers to the same element throughout the specification.

It will be understood that each block of the process flowchart illustrations and combinations of the flowchart illustrations may be executed by computer program instructions. Further, since these computer program instructions may be mounted on a processor of a general purpose computer, a special purpose computer or other programmable data processing apparatus, the instructions executed by the processor of the computer or other programmable data processing equipment may generate means for executing functions described in the flowchart block(s). In an embodiment, since these computer program instructions may also be stored in a computer-usable or computer-readable memory which may direct a computer or other programmable data processing equipment to function in a particular manner, the instructions stored in the computer-usable or computer-readable memory may produce a manufacture article including instruction means which implement the function described in the flowchart block(s). In another embodiment, since the computer program instructions may also be loaded on a computer or other programmable data processing equipment, a series of operational steps may be performed on the computer or other programmable data processing equipment to produce a computer-executed process, and thus the instructions performing the computer or other programmable data processing equipment may provide steps for executing the functions described in the flowchart block(s).

In addition, each block may represent a portion of a module, a segment or code which includes one or more executable instructions for implementing a specified logical function(s). Additionally, it should be noted that the functions mentioned in the blocks may occur out of order in some alternative implementations. Two blocks shown in succession may in fact be executed substantially concurrently or the blocks may sometimes be executed in the reverse order depending on corresponding functionality.

The term ‘unit’ as used in the embodiment indicates software or a hardware component such as a field programmable gate array (FPGA) or an application-specific integrated circuit (ASIC), and ‘unit’ performs specific roles. However, ‘unit’ is not limited to software or hardware. ‘unit’ may be configured to reside on an addressable storage medium and configured to reproduce on one or more processors. Accordingly, ‘unit’ may include, for example, components such as software components, object-oriented software components, class components and task components, processes, functions, attributes, procedures, sub-routines, segments of program code, drivers, firmware, microcode, circuitry, data, databases, data structures, tables, arrays, and variables. The functionalities provided in the components and ‘unit’ may be combined to fewer components and ‘units’ or may be further separated into additional components and ‘units’. Further, the components and ‘units’ may be implemented to reproduce one or more central processing units (CPUs) within a device or a security multimedia card. Also, ‘unit’ in one embodiment may include one or more processors.

The description of embodiments of the disclosure, for example, is mainly based on a new radio (NR) which is a radio access network and a packet core 5^{th} generation (5G) system, a 5G core network, or a next generation (NG) core which is a core network on 5G mobile communication standards specified by 3rd generation partnership project (3GPP) which is a mobile communication standardization organization, but the main subject of the disclosure may be applied to other communication systems having a similar technical background with slight modification without departing from the scope of the disclosure, which may be determined by those skilled in the art of the disclosure.

Hereafter, terms and names defined in the 3GPP standard (standards for 5G, NR, long term evolution (LTE), or similar systems) may be used for the convenience of description. The disclosure is not limited by these terms and names, and may be applied in the same way to systems conforming to other standards.

In the following description, terms for identifying access nodes, terms indicating network entities, terms indicating messages, terms indicating interfaces between network entities, terms indicating various identification information, and the like are illustratively used for the sake of convenience. Accordingly, the disclosure is not limited by the terms as used below, and other terms indicating subjects having equivalent technical meanings may be used.

A base station, which is an entity performing resource allocation of a terminal, may be at least one of a gNode B, an eNode B, a Node B, a base station (BS), a radio access unit, a base station controller, or a node on the network. In an embodiment, a terminal may include a user equipment (UE), a mobile station (MS), a cellular phone, a smartphone, a computer, or a multimedia system for executing a communication function. It is noted that the disclosure is not limited to those examples.

In particular, the disclosure may be applied to the 3GPP NR (the 5G mobile communication standard). In another embodiment, the disclosure may be applied to intelligent services based on the 5G communication and internet of things (IoT) related technologies (e.g., smart home, smart building, smart city, smart car or connected car, health care, digital education, retail, security and safety services, etc.). In the disclosure, an evolved Node B (eNB) may be interchangeably used with the gNB for convenience of description. The base station described as the eNB may also indicate the gNB. The term ‘terminal’ may indicate not only to a cell phone, an NB-IoT device, and a sensor but to other wireless communication devices as well.

In an embodiment, a wireless communication system is evolving from its early voice-oriented service to, for example, a broadband wireless communication system which provides high-speed, high-quality packet data services according to communication standards such as high speed packet access (HSPA) of 3GPP, LTE or evolved universal terrestrial radio access (E-UTRA), LTE-advanced (LTE-A), LTE-Pro, high rate packet data (HRPD) of 3 GPP2, ultra-mobile broadband (UMB), and institute of electrical and electronics engineers (IEEE) 802.16e.

As an example of the broadband wireless communication system, the LTE system employs an orthogonal frequency division multiplexing (OFDM) scheme in a downlink (DL), and a single carrier frequency division multiple access (SC-FDMA) scheme in an uplink (UL). In another embodiment, the UL indicates a radio link through which a UE or an MS transmits data or a control signal to an eNode B or a BS, and the DL indicates a radio link through which an eNode B or a BS transmits data or a control signal to a UE or an MS. Such a multi-access scheme distinguishes data or control information of each user by assigning and operating time-frequency resources for carrying the data or the control information of each user not to overlap, that is, to establish orthogonality.

As a future communication system after the LTE, that is, the 5G communication system, which should be able to freely reflect various requirements of users and service providers, should support a service for simultaneously satisfying various requirements. For example, services considered for the 5G communication system includes enhanced mobile broadband (eMBB), massive machine type communication (mMTC), ultra reliability low latency communication (URLLC) and so on.

According to one embodiment, the eMBB aims to provide a faster data rate than a data rate supported by existing LTE, LTE-A or LTE-Pro. The eMBB in the 5G communication system should be able to provide a peak data rate of 20 gigabits per second (Gbps) in the DL and 10 Gbps in the UL in terms of one base station. In addition, the 5G communication system should provide the peak data rate and concurrently provide an increased user perceived data rate of the terminal. To satisfy these requirements, improvements of various transmission and reception technologies are required, including a further advanced multi input multi output (MIMO) transmission technology. While signals are transmitted using a maximum 20 megahertz (MHz) transmission bandwidth in a 2 GHz band used by the LTE, the 5G communication system uses a frequency bandwidth wider than 20 MHz in the frequency band of 3-6 GHz or 6 GHz or higher, thus satisfying the required data rate in the 5G communication system.

At the same time, the 5G communication system is considering the mMTC to support application services such as IoT. The mMTC requires large-scale terminal access support in a cell, terminal coverage enhancement, improved battery time, and terminal cost reduction to efficiently provide the IoT. The IoT is attached to various sensors and various devices to provide communication functions and accordingly should be able to support a great number of terminals (e.g., 1,000,000 terminals/km²) in the cell. Additionally, the terminal supporting the mMTC is highly likely to be located in a shaded area not covered by the cell such as a basement of building due to its service characteristics, and thus may require wider coverage than other services provided by the 5G communication system. For example, a terminal supporting the mMTC should be configured with a low-priced terminal, and may require a quite long battery lifetime such as 10˜15 years because it is difficult to frequently replace the battery of the terminal.

Finally, the URLLC is a cellular-based wireless communication service used for mission-critical purposes. In an example, services used for robot or machinery remote control, industrial automation, unmanaged aerial vehicle, remote health care, emergency situation, or the like may be considered. Thus, the communication provided by the URLLC should provide very low latency (ultra low latency) and very high reliability (ultra high reliability). In another example, a service supporting the URLLC should meet air interface latency smaller than 0.5 milliseconds and at the same time has requirements of a packet error rate below 10⁻⁵. Hence, for the service supporting the URLLC, the 5G system should provide a transmit time interval (TTI) smaller than other services, and concurrently requires design issues for allocating a wide resource in the frequency band to obtain communication link reliability.

Three services of the 5G communication system, that is, the eMBB, the URLLC, and the mMTC may be multiplexed and transmitted in one system. To satisfy the different requirements of the respective services, different transmission and reception schemes and transmission and reception parameters may be used between the services. The aforementioned mMTC, the URLLC, and the URLLC 5G are merely examples of different service types, and the service type according to the disclosure is not limited to those examples. In an embodiment of the disclosure, a master node (MN) may be interpreted as a master base station, and an SN may be interpreted as a secondary base station. In addition, in an embodiment of the disclosure, the MN and the SN may be different base stations or base stations using different radio access technologies (RATs), and in some cases, may be base stations using the same RAT. The MN and the SN may be distinguished by using general expressions such as a first base station and a second base station.

In an embodiment of the disclosure, a radio resource control (RRC) message transmitted by the MN may be referred to as an MN RRC message. In another embodiment, an RRC message generated by the SN may be referred to as an SN RRC message.

Intra-SN conditional primary secondary cell group (SCG) (PS) cell change (CPC) of Release 16 is initiated by the SN, and an SN RRC message delivers candidate target PScell configuration to a UE. By contrast, inter-SN CPC of Release 17 is initiated by the MN or the SN, and an MN RRC message delivers candidate target PScell configuration to a UE. In an embodiment, if the network is to configure both the Rel-16 intra-SN CPC and the Rel-17 inter-SN CPC for the UE, configuration, measurement and condition evaluation of the candidate target PScell of the UE may be performed based on a specific number of candidate PScells. Hence, the MN and the SN should negotiate the maximum number of their CPC configurations, not to exceed the maximum number of the CPC configuration and measurement values operable according to UE capability.

In another embodiment, if the CPC configuration is transmitted to the UE, the SN allocates an ID indicating each candidate target PScell configuration in the intra-SN, and the MN allocates the same in the inter-SN. If every CPC configuration is stored in one storage, that is, in one variable, ID collision may occur because the IDs are allocated by different entities.

In still another embodiment, if the two CPCs are configured and operated in the UE and the intra-SN CPC is successful, the inter-SN CPC configuration may be deleted under a specific condition.

According to some embodiments, the UE may be prevented from exceeding the UE capability according to the CPC configuration of the MN and the SN. In addition, an error due duplicate IDs between a plurality of CPC configurations may be prevented. The inter-SNS CPC configuration may be efficiently managed, thanks to the intra-SN CPC.

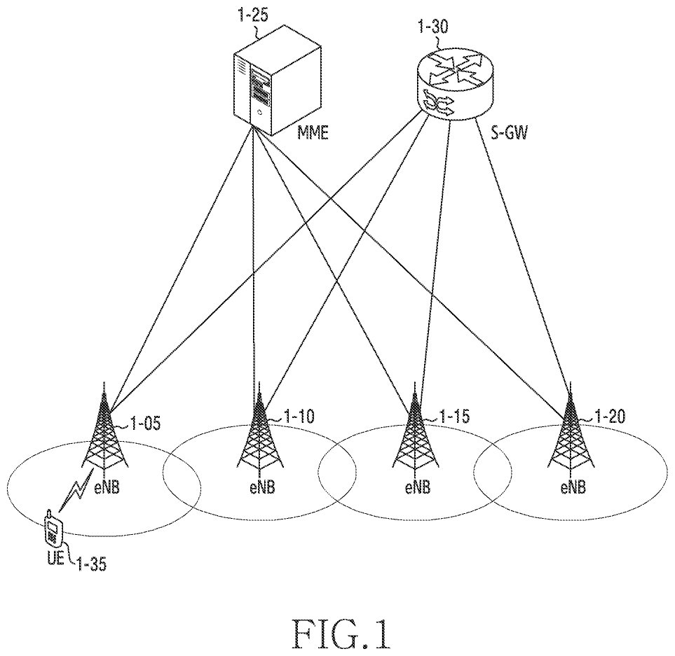

FIG. 1 is a diagram illustrating an LTE system structure according to an embodiment of the disclosure.

Referring to FIG. 1, a radio access network of the LTE system as shown may include eNBs, Node Bs or BSs 1-05, 1-10, 1-15, and 1-20 and a mobility management entity (MME) 1-25 and a serving-gateway (S-GW) 1-30. In an embodiment, a UE or terminal 1-35 may access an external network via the eNBs 1-05 through 1-20 and the S-GW 1-30.

In FIG. 1, eNBs 1-05 through 1-20 may correspond to existing Node Bs of a universal mobile telecommunication system (UMTS). In another embodiment, the eNB may be connected to a UE 1-35 over a radio channel to perform a more complex role than the existing Node B. In an LTE system, every user traffic including a real-time service such as voice over internet protocol (IP) (VoIP) may be serviced over a shared channel A device for collecting and scheduling status information such as buffer status, available transmission power status, and channel status of UEs is required, which may be managed by the eNBs 1-05 through 1-20. One eNB may typically control a plurality of cells. To implement a data rate of 100 Mbps, the LTE system may use, but not limited to, OFDM as the radio access technology in a 20 MHz bandwidth. In addition, the eNBs 1-05 through 1-20 may adopt an adaptive modulation & coding (AMC) scheme which determines a modulation scheme and a channel coding rate according to the UE channel state. An S-GW 1-30 is a device for providing a data bearer, and may create or remove a data bearer under control of an MME 1-25. In still another embodiment, the MME is a device responsible for various control functions as well as the mobility management function of the UE, and may be connected to a plurality of eNBs.

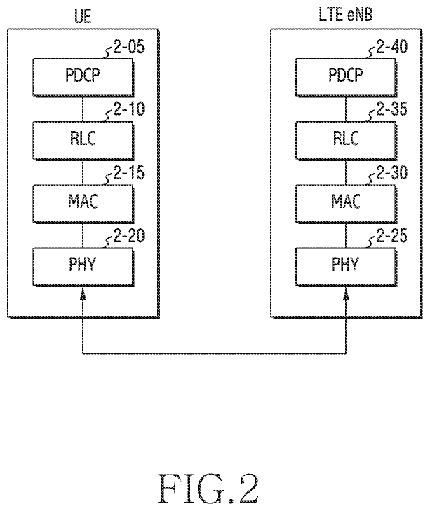

FIG. 2 is a diagram illustrating a radio protocol structure of an LTE system according to an embodiment of the disclosure.

Referring to FIG. 2, a radio protocol of an LTE system may include packet data convergence protocols (PDCPs) 2-05 and 2-40, radio link control (RLCs) 2-10 and 2-35, medium access control (MACs) 2-15 and 2-30, and physical layer (PHYs) 2-20 and 2-25 in the UE and the eNB respectively. Notably, the radio protocol of the LTE system may include more or less layers than the configuration shown in FIG. 2.

According to one embodiment of the disclosure, the PDCP is responsible for IP header compression/decompression. Main functions of the PDCP may be summarized, but not limited to, as below.
Header compression and decompression: robust header compression (ROHC) only.
Transfer of user data.
In-sequence delivery of upper layer packet data units (PDUs) at PDCP re-establishment procedure for RLC acknowledged mode (AM).
For split bearers in dual connectivity (DC) (only support for RLC AM): PDCP PDU routing for transmission and PDCP PDU reordering for reception.
Duplicate detection of lower layer service data units (SDUs) at PDCP re-establishment procedure for RLC AM.
Retransmission of PDCP SDUs at handover and, for split bearers in DC, of PDCP PDUs at PDCP data-recovery procedure, for RLC AM.
Ciphering and deciphering.
Timer-based SDU discard in uplink.

According to another embodiment of the disclosure, the RLCs 2-10 and 2-35 may reconstruct the PDCP PDU in an appropriate size and perform an automatic repeat request (ARQ) operation. The main functions of the RLC may be summarized, but not limited to, as below.
Transfer of upper layer PDUs.
Error Correction through ARQ (only for AM data transfer).
Concatenation, segmentation and reassembly of RLC SDUs (only for unacknowledged mode (UM) and AM data transfer).
Re-segmentation of RLC data PDUs (only for AM data transfer).
Reordering of RLC data PDUs (only for UM and AM data transfer).
Duplicate detection (only for UM and AM data transfer).
Protocol error detection (only for AM data transfer).
RLC SDU discard (only for UM and AM data transfer).
RLC re-establishment.

According to still another embodiment of the disclosure, the MACs 2-15 and 2-30 may be connected to several RLC layer devices configured in one terminal, and may multiplex RLC PDUs into a MAC PDU and demultiplex RLC PDUs from a MAC PDU. The main functions of the MAC may be summarized, but not limited to, as below.
Mapping between logical channels and transport channels.
Multiplexing/demultiplexing of MAC SDUs belonging to one or different logical channels into/from transport blocks (TB) delivered to/from the physical layer on transport channels.
Scheduling information reporting.
Error correction through hybrid ARQ (HARQ).
Priority handling between logical channels of one UE.
Priority handling between UEs by means of dynamic scheduling.
Multimedia broadcast multicast service (MBMS) service identification.
Transport format selection.
Padding.

According to an embodiment, the PHYs 2-20 and 2-25 may, but not limited to, channel-code and modulate upper layer data, generate OFDM symbols and transmit them over a radio channel, or demodulate OFDM symbols received over the radio channel, channel-decode, and deliver them to an upper layer.

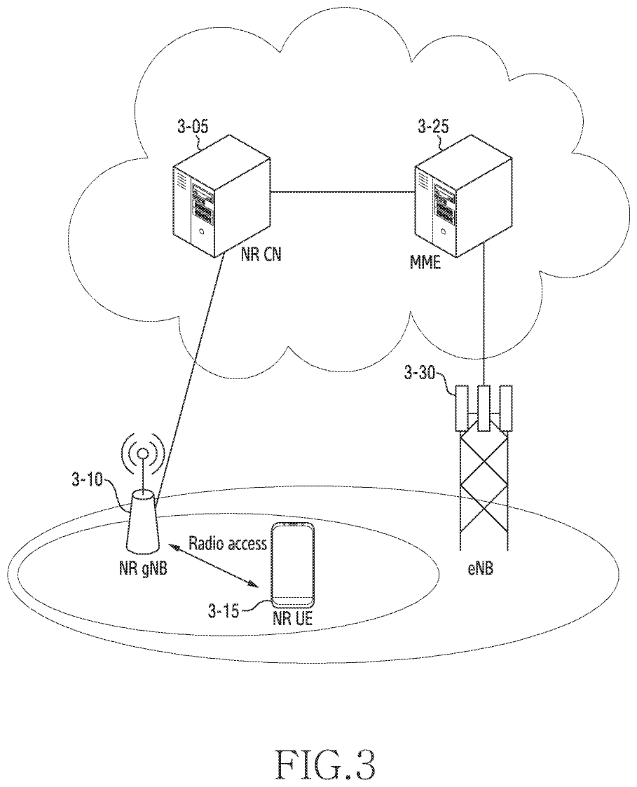

FIG. 3 is a diagram of a structure of a next generation mobile communication system according to an embodiment of the disclosure.

Referring to FIG. 3, a radio access network of a next generation mobile communication system (e.g., NR or 5G) may include an NR node B, an NR gNB or an NR base eNB 3-10 and a NR core network (CN) 3-05. In an embodiment, a NR UE or a terminal 3-15 may access an external network via the NR gNB 3-10 and the NR CN 3-05.

In FIG. 3, an NR gNB 3-10 may correspond to an eNB of an existing LTE system. In another embodiment, the NR gNB 3-10 is connected to an NR UE 3-15 over a radio channel and may provide a superior service compared to the existing NB. All user traffic data may be serviced over a shared channel in the next generation mobile communication system. A device for collecting buffer status information, available transmission power status information, channel status information of UEs and performing scheduling is required, which may be performed by the NR gNB 3-10. One NR gNB may control a plurality of cells.

According to one embodiment of the disclosure, in the next generation mobile communication system, a bandwidth greater than the current maximum bandwidth may be adopted, to achieve an ultrahigh data rate compared to the current LTE. Beamforming technology may be additionally used with the OFDM as the radio access technology.

According to another embodiment of the disclosure, the AMC may be adopted to determine the modulation scheme and the channel coding rate according to the channel status of the UE. The NR CN 3-05 may perform functions such as mobility support, bearer setup, and quality of service (QoS) setup. In yet another embodiment, the NR CN 3-05 performs various control functions as well as the mobility management function of the UE and may be connected to a plurality of NR gNBs. The next generation mobile communication system may interwork with the existing LTE system, and the NR CN 3-05 may be connected to an MME 3-25 through a network interface. The MME 3-25 may be connected to an existing eNB 3-30.

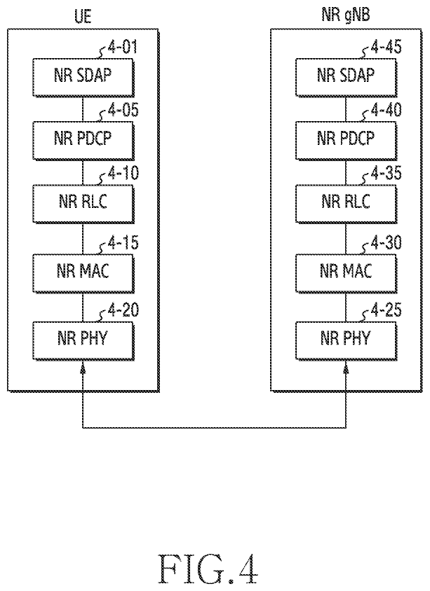

FIG. 4 is a diagram of a radio protocol structure of a next generation mobile communication system according to an embodiment of the disclosure.

Referring to FIG. 4, a radio protocol structure of a next generation mobile communication system may include NR service data adaptation protocol (SDAP) layers 4-01 and 4-45, NR PDCP layers 4-05 and 4-40, NR RLC layers 4-10 and 4-35, NR MAC layers 4-15 and 4-30, and NR PHY layers 4-20 and 4-25 in the UE and the NR gNB, respectively. It is noted that the radio protocol structure of the next generation mobile communication system may include more or less layer than the configuration shown in FIG. 4.

In an embodiment of the disclosure, main functions of the NR SDAP layers 4-01 and 4-45 may include, but not limited to, some of the following functions.
Transfer of user plane data.
Mapping between QoS flow and a data radio bearer (DRB) for both DL and UL.
Marking QoS flow ID in both DL and UL packets.
Reflective QoS flow to DRB mapping for the UL SDAP PDUs.

Whether to use a header of the SDAP layer device or a function of the SDAP device 4-01 and 4-45 for each PDCP layer device, bearer, or logical channel may be configured for the UE via an RRC message with respect to the SDAP device (hereafter, used interchangeably with the layer and the layer device) 4-01 and 4-45. In another embodiment, if the SDAP header is configured, the UE may instruct to update or reconfigure mapping information of the UL and DL QoS flow and the data bearer, with a 1-bit non-access stratum (NAS) reflective QoS indicator and a 1-bit access stratum (AS) reflective QoS indicator of the SDAP header. According to an embodiment, the SDAP header may include QoS flow ID indicating the QoS. Also, according to an embodiment, QoS information may be used as data processing priority information, scheduling information, and so on, for supporting a smooth service.

In another embodiment of the disclosure, main functions of the NR PDCP layers 4-05 and 4-40 may include, but not limited to, some of the following functions.
Header compression and decompression: ROHC only.
Transfer of user data.
In-sequence delivery of upper layer PDUs.
Out-of-sequence delivery of upper layer PDUs.
PDCP PDU reordering for reception.
Duplicate detection of lower layer SDUs.
Retransmission of PDCP SDUs.
Ciphering and deciphering.
Timer-based SDU discard in uplink.

In yet another embodiment, the reordering of the NR PDCP device 4-05 and 4-40 may indicate reordering PDCP PDUs received from a lower layer based on a PDCP sequence number (SN). The reordering, for example, of the NR PDCP device 4-05 and 4-40 may include at least one of delivering the reordered data to an upper layer in order, immediately delivering the reordered data without considering the order, recording missing PDCP PDUs by reordering the PDCP PDUs, reporting status information of the missing PDCP PDUs to a transmitter, and requesting to retransmit the missing PDCP PDUs.

In still another embodiment of the disclosure, main functions of the NR RLC device 4-10 and 4-35 may include, but not limited to, some of the following functions.
Transfer of upper layer PDUs.
In-sequence delivery of upper layer PDUs.
Out-of-sequence delivery of upper layer PDUs.
Error correction through ARQ.
Concatenation, segmentation and reassembly of RLC SDUs.
Re-segmentation of RLC data PDUs.
Reordering of RLC data PDUs.
Duplicate detection.
Protocol error detection.
RLC SDU discard.
RLC re-establishment.

According to one embodiment, the in-sequence delivery of the NR RLC device 4-10 and 4-35 may indicate delivering RLC SDUs received from a lower layer to an upper layer in order. The in-sequence delivery of the NR RLC device 4-10 or 4-35 may include, if receiving one original RLC SDU segmented into several RLC SDUs, reassembling and delivering them.

According to another embodiment, the in-sequence delivery of the NR RLC device 4-10 and 4-35 may include at least one of reordering the received RLC PDUs based on the RLC SN or the PDCP SN, recording missing RLC PDUs by reordering the RLC PDUs, reporting status information of the missing RLC PDUs to a transmitter, and requesting to retransmit the missing RLC PDUs.

According to yet an embodiment, the in-sequence delivery of the NR RLC device 4-10 and 4-35 may include at least one of delivering, if a missing RLC SDU exists, only RLC SDUs prior to the missing RLC SDU to the upper layer in order, delivering, if a missing RLC SDU exists but a specific timer expires, all RLC SDUs received before the timer start to the upper layer in order, and delivering all RLC SDUs received so far to the upper layer in order if a missing RLC SDU exists but a specific timer expires.

According to still another embodiment, the NR RLC device 4-10 and 4-35 may process the RLC PDUs in order of the reception and deliver them to the NR PDCP device regardless of the SN (out of sequence delivery).

In an embodiment of the disclosure, the NR RLC device 4-10 and 4-35 may, if receiving segments, receive and reassemble segments stored in a buffer or to be received, into a whole RLC PDU and then deliver it to the NR PDCP device.

In another embodiment of the disclosure, the NR RLC device 4-10 and 4-35 may not include a concatenation function, which may be performed by the NR MAC layer or replaced with the multiplexing function of the NR MAC layer.

The out-of-sequence delivery of the NR RLC device may indicate delivering the RLC SDUs received from a lower layer to an upper layer out of order. In addition, the out-of-sequence delivery of the NR RLC device may include reassembling and delivering several RLC SDUs segmented from one original RLC SDU. Additionally, the out-of-sequence delivery of the NR RLC device may include recording missing RLC PDUs by storing RLC SNs or PDCP SNs of the received RLC PDUs and ordering the RLC PDUs.

In an embodiment of the disclosure, the NR MAC device 4-15 and 4-30 may be connected to several NR RLC layer devices configured in one UE, and main functions of the NR MAC layer 4-15 or 4-30 may include, but not limited to, some of the following functions.
Mapping between logical channels and transport channels.
Multiplexing/demultiplexing of MAC SDUs.
Scheduling information reporting.
Error correction through HARQ.
Priority handling between logical channels of one UE.
Priority handling between UEs by means of dynamic scheduling.
Multimedia broadcast multicast service (MBMS) service identification.
Transport format selection.
Padding.

In another embodiment, the NR PHY layer 4-20 and 4-25 may, but not limited to, channel-code and modulate upper layer data into OFDM symbols and transmit them over a radio channel, or demodulate OFDM symbols received over a radio channel and channel-decode and deliver them to an upper layer.

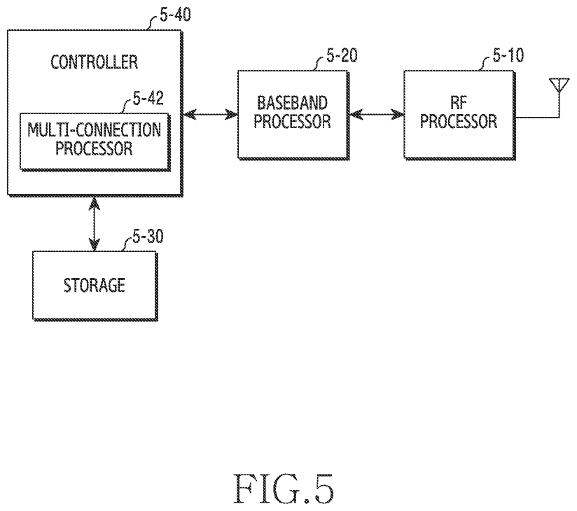

FIG. 5 is a block diagram illustrating an internal structure of a UE according to an embodiment of the disclosure.

Referring to FIG. 5, a UE may include a radio frequency (RF) processor 5-10, a baseband processor 5-20, a storage 5-30, and a controller 5-40. The UE is not limited to this example and the UE may include more or less components than the components shown in FIG. 5.

In an embodiment, the RF processor 5-10 may perform functions for transmitting and receiving signals over a radio channel, such as signal band conversion and amplification. That is, the RF processor 5-10 may up-convert a baseband signal provided from the baseband processor 5-20 to an RF band signal and transmit it via an antenna, and down-convert an RF band signal received via an antenna, to a baseband signal. In an example, the RF processor 5-10 may include a transmit filter, a receive filter, an amplifier, a mixer, an oscillator, a digital to analog converter (DAC), and an analog to digital converter (ADC). Although only a single antenna is illustrated in FIG. 5, the UE may include a plurality of antennas. In another embodiment, the RF processor 5-10 may include a plurality of RF chains. Further, the RF processor 5-10 may perform the beamforming. For the beamforming, the RF processor 5-10 may adjust phases and amplitudes of signals transmitted or received through a plurality of antennas or antenna elements. In yet another embodiment, the RF processor 5-10 may perform multiple input multiple output (MIMO), and may receive several layers in the MIMO operation. The RF processor 5-10 may perform receive beam sweeping by appropriately configuring a plurality of antennas or antenna elements, or adjust a direction and a beam width of the receive beam to coordinate with a transmit beam, under the control of the controller 5-40.

According to an embodiment, the baseband processor 5-20 may convert between a baseband signal and a bitstream based on physical layer specifications of the system. For example, in data transmission, the baseband processor 5-20 may generate complex symbols by encoding and modulating a transmit bitstream. In the data reception, the baseband processor 5-20 may restore a received bitstream by demodulating and decoding a baseband signal provided from the RF processor 5-10. According to the OFDM scheme, in data transmission, the baseband processor 5-20 may generate complex symbols by encoding and modulating a transmit bitstream, map the complex symbols to subcarriers, and then configure OFDM symbols by performing inverse fast Fourier transformation (IFFT) and cyclic prefix (CP) insertion. In data reception, the baseband processor 5-20 may split a baseband signal provided from the RF processor 5-10 into OFDM symbol, restore signals mapped to subcarriers using fast Fourier transformation (FFT), and then restore a received bitstream by demodulating and decoding the signals.

According to another embodiment, the baseband processor 5-20 and the RF processor 5-10 may transmit and receive the signals as described above. The baseband processor 5-20 and the RF processor 5-10 may be referred to as a transmitter, a receiver, a transceiver, or a communicator. Further, at least one of the baseband processor 5-20 or the RF processor 5-10 may include a plurality of communication modules to support multiple different radio access technologies. Also, at least one of the baseband processor 5-20 or the RF processor 5-10 may include different communication modules to process signals of different frequency bands. The different radio access technologies may include a wireless local area network (LAN) (e.g., IEEE 802.11), a cellular network (e.g., LTE), and the like. In addition, the different frequency bands may include a super high frequency (SHF) (e.g., 2.NR Hz and NR Hz) band and a millimeter wave (mmWave) (e.g., 60 GHz) band. The UE, for example, may transmit or receive a signal to or from a base station by using the baseband processor 5-20 and the RF processor 5-10, and the signal may include control information and data.

The storage 5-30 may store a basic program for the operations of the UE, an application program, and data such as configuration information. In an example, the storage 5-30 may store information related to a second access node which performs wireless communication using a second wireless access technology. In addition, the storage 5-30 provides the stored data at a request of the controller 5-40. The storage 5-30 may include a plurality of memories. According to another embodiment, the storage 5-30 may store a program for executing the CPC method explained in the disclosure.

According to yet another embodiment, the controller 5-40 may control general operations of the UE. In an example, the controller 5-40 may transmit and receive signals through the baseband processor 5-20 and the RF processor 5-10. The controller 5-40 may record and read data on and from the storage 5-30. For doing so, the controller 5-40 may include at least one processor. In another example, the controller 5-40 may include a communication processor (CP) for controlling the communications and an application processor (AP) for controlling an upper layer such as an application program. At least one configuration in the UE may be implemented with a single chip. According to still another embodiment, the controller 5-40 may include a multi-connection processor 5-42 for operating in a multi-connection mode.

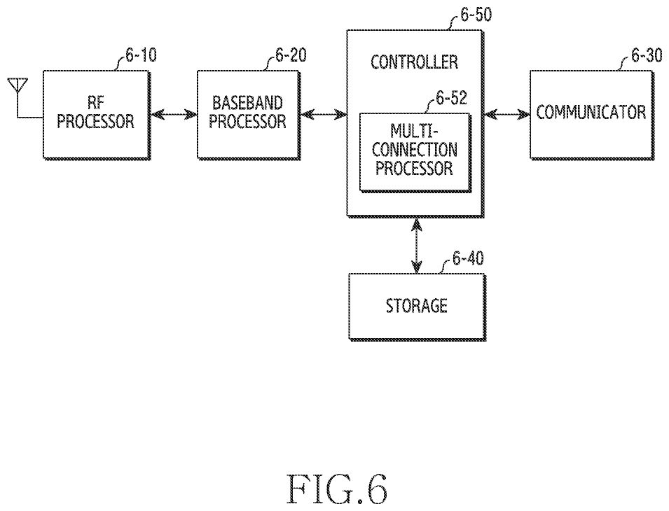

FIG. 6 is a block diagram illustrating a configuration of an NR gNB according to an embodiment of the disclosure.

Referring to FIG. 6, a gNB may include an RF processor 6-10, a baseband processor 6-20, a backhaul communicator 6-30, a storage 6-40, and a controller 6-50. Notably, the gNB is not limited to this example, and the gNB may include more or less components than those shown in FIG. 6.

According to one embodiment of the disclosure, the RF processor 6-10 may perform functions for transmitting and receiving a signal over a radio channel, such as signal band conversion and amplification. The RF processor 6-10 may up-convert a baseband signal provided from the baseband processor 6-20, to an RF band signal and transmit it over an antenna, and down-convert an RF band signal received through an antenna, to a baseband signal. For example, the RF processor 6-10 may include a transmit filter, a receive filter, an amplifier, a mixer, an oscillator, a DAC, and an ADC. Although only a single antenna is illustrated in FIG. 6, the gNB may include a plurality of antennas. In addition, the RF processor 6-10 may include a plurality of RF chains. The RF processor 6-10 may perform the beamforming. For the beamforming, the RF processor 6-10 may adjust phases and amplitudes of signals transmitted or received via a plurality of antennas or antenna elements. The RF processor 6-10 may perform DL MIMO by transmitting one or more layers.

According to another embodiment of the disclosure, the baseband processor 6-20 may convert between a baseband signal and a bitstream based on physical layer specifications of a first radio access technology. In an example, in data transmission, the baseband processor 6-20 may generate complex symbols by encoding and modulating a transmit bitstream. In data reception, the baseband processor 6-20 may restore a received bitstream by demodulating and decoding a baseband signal provided from the RF processor 6-10. In another example, according to the OFDM scheme, in data transmission, the baseband processor 6-20 may generate complex symbols by encoding and modulating a transmit bitstream, map the complex symbols to subcarriers, and then configure OFDM symbols by performing IFFT and CP insertion. In data reception, the baseband processor 6-20 may split a baseband signal provided from the RF processor 6-10, into OFDM symbols, restore signals mapped to subcarriers by performing FFT, and then restore a received bitstream by demodulating and decoding the signals. The baseband processor 6-20 and the RF processor 6-10 may, for example, transmit and receive the signals as described above. The baseband processor 6-20 and the RF processor 6-10 may be referred to as a transmitter, a receiver, a transceiver, a communicator, or a wireless communicator.

According to yet another embodiment of the disclosure, the communicator 6-30 may provide an interface for communicating with other nodes in the network. That is, the communication unit 6-30 may convert a bitstream transmitted from the main base station to other node, for example, an auxiliary base station, a core network, and so on, into a physical signal, and convert a physical signal received from the other node into a bitstream.

The storage 6-40 may store a basic program for operations of the main base station, an application program, and data such as configuration information. For example, the storage 6-40 may store information of a bearer allocated to a connected UE, a measurement report transmitted from the connected UE, and the like. In an embodiment, the storage 6-40 may store information used to determine whether to provide or release multi-connectivity to or from the UE. In another embodiment, the storage 6-40 may provide the stored data at a request of the controller 6-50. In still another embodiment, the storage 6-40 may be configured with a storage medium such as a read only memory (ROM), a random access memory (RAM), a hard disk, a compact disc (CD)-ROM, or a digital versatile disc (DVD), or a combination thereof. Also, the storage 6-40 may be configured with a plurality of memories. According to an embodiment, the storage 6-40 may store a program for executing the CPC method explained in the disclosure.

The controller 6-50 may control general operations of the gNB. For example, the controller 6-50 may transmit and receive signals through the baseband processor 6-20 and the RF processor 6-10 or through the backhaul communicator 6-30. In an embodiment, the controller 6-50 may record and read data on and from the storage 6-40. For doing so, the controller 6-50 may include at least one processor. At least one configuration of the gNB may be implemented with a single chip. The controller 6-50 may control the operation of the base station or the corresponding entity according to various embodiments of the disclosure. According to another embodiment of the disclosure, the controller 6-50 may include a multi-connection processor 6-52.

Each configuration of the base station may operate to fulfill the aforementioned embodiments of the disclosure.

In some embodiments of the disclosure, dual connection may include all of LTE-NR dual connectivity (EN-DC), NR-DC, multi-RAT (MR)-DC. Various embodiments of the disclosure may include operations of the network and the UE according to the RATs of the MN and the SN based on this dual connection.

Hereafter, terms used in the disclosure are as follows.

SN: secondary node.

MN: master node.

MCG: master cell group.

SCG: secondary cell group.

Pcell: primary cell.

PScell: Primary SCG (secondary cell group) cell.

SCell: secondary cell.

SpCell: special cell.

CHO: conditional handover.

CPC: conditional PScell change.

CPAC: conditional PScell addition and change.

S-SN: source SN.

T-SN: target SN.

SNModReq: SN Modification Required message.

SNChangeReq: SN Change Required message.

SNAddReq: SN Addition Request message.

SNAddReqACK; SN Addition Request Acknowledge message.

SNModConfirm: SN Modification Confirm message.

SI-CPC: SN-initiated CPC.

MI-CPC: MN-initiated CPC.

The CPC per release of the 3GPP has the following characteristics.

R16 CPC:
S-SN makes the final RRCReconfiguration msg and gives (or transmits) to UE via SRB1 or SRB3.
MN is not involved.
UE has dedicated Variable.

R17 CPC:
MN makes the final RRCReconfiguration msg and gives (or transmits) to UE via SRB1.
MN assigns condReconfig ID for every case.
MN starts the procedure for CPA and MI-CPC while SN start the procedure for SI-CPC.
UE has dedicated Variable.

For both:
Each condReconfigToAddMod has.
   CondReconfig Id.
   Condition a.k.a measIds.
   condRRCReconfig as octet string.

The MN and the SN need to negotiate the maximum number of conditional reconfigurations allowed for their CPC, or the number of configurable candidate target PScell configurations in the CPC operation. The MN may obtain UE capability information in the RRC connected state. The MN may obtain at least one of the following information, from the UE capability information.
the maximum number of conditional reconfigurations or the maximum number of candidate target PScell configurations of CPAC operable at MN.
the maximum number of conditional reconfigurations or the maximum number of candidate target PScell configurations of CPAC operable at SN.
the maximum number of conditional reconfigurations or the maximum number of candidate target PS cell configurations of Rel-16 CPC operable at SN.
the maximum number of conditional reconfigurations or the maximum number of candidate target PS cell configurations of Rel-17 CPC operable at SN.
the maximum number of conditional reconfigurations or the maximum number of candidate target PS cell configurations of Rel-17 SN-initiated CPC operable at SN.

The MN obtaining the above information may transmit at least one of the following information to the SN, during the SN addition procedure or after the SN addition procedure with the UE.

A: the maximum number of conditional reconfigurations or the maximum number of candidate target PS cell configurations of CPAC operable at SN.

B: the maximum number of conditional reconfigurations or the maximum number of candidate target PS cell configurations of Rel-16 CPC operable at SN.

C: the maximum number of conditional reconfigurations or the maximum number of candidate target PS cell configurations of Rel-17 CPC operable at SN.

D: the maximum number of conditional reconfigurations or the maximum number of candidate target PS cell configurations of Rel-17 SN-initiated CPC operable at SN.

The SN receiving the above information may perform the following operation, if configurating the CPC for the UE.

If receiving A: If configuring the CPAC for the UE, the SN may configure the CPAC to be below the corresponding maximum number, that is, the SN-initiated CPC configurations of Rel-16 CPC and Rel-17 CPC for the UE.

If receiving B, without A: The SN may configure the CPC for the UE to be below the maximum number B of Rel-16 CPC.

If receiving B and (C or D), without A: The SN may configure the CPC configurations for the UE, the CPC configurations below the maximum number B of Rel-16 CPC, and the CPC configurations below the maximum number C or D of the Rel-17 CPC or the SN-initiated CPC.

The information of the maximum number of the conditional reconfigurations transmitted from the MN to the SN may be delivered by SNAddRequest, SNModificationRequest or other Xn message, and a field indicating the corresponding information may be included in an RRC container of the message.

In another embodiment, the SN may request the maximum number information of Rel-16 and/or Rel-17 CPC configuration from the MN. The SN may determine the maximum number of the CPC configurations. In this case, the MN may identify the received maximum number information, and then accept or reject it. At this time, the information transmitted form the SN to the MN may be at least one of A, B, C, and D.

In an embodiment, if the MN and the SN receiving the maximum number information of the conditional reconfigurations from the UE configure Rel-17 CPAC and Rel-16 CPC respectively for the UE, the MN and the SN may configure Rel-17 CPAC and Rel-16 CPC within the maximum number of the conditional reconfigurations. In another embodiment, if configuring Rel-17 CPAC and Rel-16 CPC for the UE, the MN and the SN may transmit the configuration information to the UE through an RRC(connection)Reconfiguration message of the MN and RRC(connection)Reconfiguration of the SN. In so doing, an ID for distinguishing each configuration may be allocated to each conditional reconfiguration information, the MN allocates the ID in Rel-17 CPAC, and the SN allocates the ID in Rel-16 CPC. Hence, if different entities allocate the ID without negotiation on ID usage between the MN and the SN to allocate the same ID and accordingly ID collision may occur, in particular, if the UE stores and manages the conditional reconfiguration information using a single variable and a plurality of conditional reconfiguration information has the same ID, it is not clear which conditional reconfiguration is to be added/modified/released. To address this problem, the disclosure provides the following embodiments.

In one embodiment, the UE may use two separate variables. In another embodiment, the UE may perform the following operations, after capability coordination between the MN and the SN.
UE upon receiving conditionalReconfiguration field included in RRCReconfiguration received via SRB3 or receiving conditionalReconfiguration included in RRCReconfiguration which is further embedded in mrdc or endc secondaryCellgroupConfiguration of RRC(Connection)Reconfiguration msg via SRB1→which means R16 CPC config from SN.
   UE creates VarConditionalReconfig-SN specific to SN's conditionalReconfiguration management if not created, and
For each condReconfigID with addition/modification indication in the above received conditional Reconfiguration field,
   if there is no existing condReconfigID in the VarConditionalReconfig-SN, UE adds that conditional Reconfiguration into the VarConditionalReconfig.
   If there is existing condReconfigID in the VarConditionalReconfig-SN, UE modifies (or updates) the conditional Reconfiguration contents having existing ID in Variable with the newly received condition or condRRCReconfig (which is the target pscell configuration).
For each condReconfigID with release indication (i.e., condReconfigToRelease) in the above received conditional Reconfiguraion field,
   If there is existing condReconfigID in the VarConditionalReconfig-SN, then UE releases that entry with the matching ID from that VarConditionalReconfig-SN.
UE upon receiving conditionalReconfiguratoin included in MN's RRC(Connection)Reconfiguration received via SRB1→which means R17 CPC or CPA config from MN.
UE creates VarConditionalReconfig specific to MN (say VarConditionalReconfig-MN) if not created, and for each condReconfigID with addition/modification indication in the above received conditional Reconfiguration field,
   if there is no existing condReconfigID in the VarConditionalReconfig-MN, UE adds that conditional Reconfiguration into the VarConditionalReconfig.
   If there is existing condReconfigID in the VarConditionalReconfig-MN, UE modifies (or updates) the conditional Reconfiguration contents having existing ID in Variable with the newly received condition or condRRCReconfig (which is the target pscell configuration).
   For each condReconfigID with release indication (i.e., condReconfigToRelease) in the above received conditional Reconfiguraion field,
   If there is existing condReconfigID in the VarConditionalReconfig-MN, then UE releases that entry with the matching ID from that VarConditionalReconfig-MN
measID as a conditional Reconfiguration execution condition for R17 CPA and R17 MI-CPC in VarConditionalReconfig-MN refers to the measID in MCG measconfig while measID as a conditional Reconfiguartion execution condition for R17 SI-CPC and R16 CPC in VarConditionalReconfig-SN refers to the measID in SCG measConfig.

In one embodiment, if R16 CPC and R17 CPC are configured at the same time and R16 CPC is successfully executed, the SN is modified, rather than changing the SN. Hence, the UE may not perform UE autonomous release, with respect to the stored R17 CPC, and the SN may perform the S-SN initiated CPC modification procedure, by considering the target PScell as the source, and provide the updated R17 CPC configuration to the UE.

In another embodiment, the UE stores the R17 CPC configuration information provided from the MN and the R16 CPC configuration information provided from the SN using the single variable, but may also store the indicators indicating the information provided from the MN and SN. By including two subfields in the variable and storing the conditional reconfigurations provided by the MN and the SN in the subfields respectively, the operation such as addition/modification/release may be performed on the new configurations.
UE upon receiving conditionalReconfiguration included in RRCReconfiguration received via SRB3 or receiving conditionalReconfiguration included in RRCReconfiguration embedded in mrdc or endc secondaryCellgroupConfiguration of RRC(Connection)Reconfiguration msg via SRB1→which means R16 CPC config from SN.
Each condReconfigToAddMod entry is stored a single Variable with the indicator of R16 CPC or SN assigned condReconfig ID.
Add/mod/release operation is done only within the entries with the same indicator of R16 CPC.
UE upon receiving conditionalReconfiguration included in RRC(Connection)Reconfiguration received via SRB1→which means R17 CPC or CPA config from MN.
Each condReconfigToAddMod entry is stored a single Variable with the indicator of R17 CPAC or MN assigned condReconfig ID.
or without any indication as above).
UE creates VarConditionalReconfig if not created, and add/mod/release operation is done only within the entries with the same indicator or no indicator.
measID for R17 CPA, MI-CPC in R17 CPAC Var refers to MN measconfig, SI-CPC measID in R17 CPAC Var and CPC measID in R16 CPC Var refers to SCG measConfig.

In an embodiment, the MN and the SN may negotiate an available condReconfig ID. If the maximum number of the conditional reconfigurations of the MN and the SN is determined, the MN and the SN may negotiate the ID range to allocate, in providing the conditional reconfiguration to the UE. According to an embodiment, a separate variable is used, or one variable requires no separate MN indicator and/or SN indicator.
MN may provide at least one of the following information to the SN.
a range of the maximum value and the minimum value of the conditional reconfiguration ID allocated by SN.
a minimum value of the conditional reconfiguration ID allocated by SN.
SN receiving the above information may create conditional reconfigurations corresponding to its received maximum number of the conditional reconfigurations, and define the condReconfig ID value of each conditional reconfiguration as below.
allocate ID using an integer between the minimum value and the maximum value received from MN (if the range is provided).
allocate ID using an integer corresponding to the maximum number of conditional reconfigurations previously received, based on the minimum value (if only minimum value is provided).

After receiving the MN and/or SN CPC configuration information, if a specific CPC performed, the UE may perform the following operations in relation to deleting the other conditional reconfigurations in the CPC operation.
If both R16 CPC and R17 CPAC are configured together,
Upon R16 CPC executed successfully,
   Opt 1. autonomous release all the CPAC (for the same reason with legacy CHO/CPC, that is, source configuration is changed. Serving frequency may be changed. Accordingly, the existing candidate target PScell requires reconfiguration based on the changed information. If R17 CPC is delta configuration). CPAC is performed again based on the new PScell.
   Opt 2. only R16 CPC is released, and R17 CPC is not deleted. (if the serving frequency is changed, R17 CPC candidate target PScell is PS cell of a totally different frequency, and R17 CPC is full config) For doing so, RRC message may include an indicator.
The indicator may indicate no deleting R17 CPC, after successful R16 CPC.

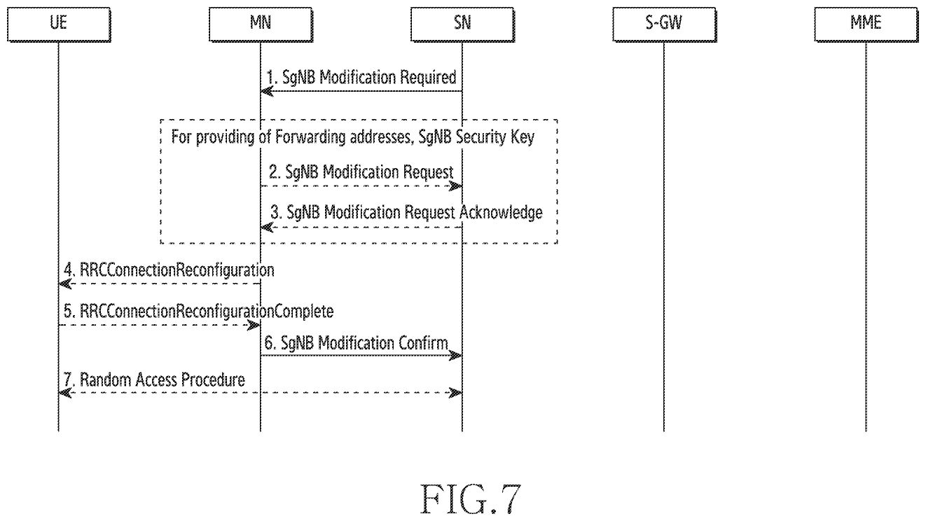

In yet another embodiment, even if the R16 CPC operation, as the intra-SN CPC, is without ML involvement, the MN may be intentionally involved to allocate condReconfig ID. In the intra-SN CPC without MN involvement, the SN creates and directly provides CPC configuration to the UE via SRB3, or provides via SRB1 by encapsulating it in RRC(connection)Reconfiguration message of the MN, which is described by referring to FIG. 7.

FIG. 7 is a diagram illustrating a method for allocating a CPC configuration ID at an MN, if intra-SN CPC configuration is provided to a UE according to an embodiment of the disclosure.

Referring to FIG. 7, in an embodiment, an SN may create an intra-SN CPC configuration, and then provide an indicator indicating that configuration information and the intra-SN CPC configuration are included, to the MN (operation 1). In an embodiment, an Xn message may be SN Modification Required. Until the intra-SN CPC configuration information is provided to the UE, the MN may provide the SN with a forwarding address required to update a security key or to deliver user data. This information delivery may include SN modification Request (operation 2) and SN Modification Request ACK (operation 3) delivering a modification configuration response from the SN. The MN receiving the intra-SN CPC configuration information in step 1 may indicate the received intra-SN CPC configuration information to the UE by including it into conditionalReconfiguration field of RRC(connection)Reconfiguration message of the MN (operation 4). At this time, the MN may determine and allocate condReconfig ID of the intra-SN CPC configuration, and encapsulate and provide it in conditionalReconfiguration field to the UE. The UE may report the intra-SN CPC configuration reception to the MN using RRCReconfigurationComplete message (operation 5). The MN may notify the SN of the successful delivery of the intra-SN CPC configuration information to the UE using SN modification Request ACK message (operation 6). Thus, the MN may control both the intra-SN CPC (previous Rel-16 CPC) and the inter-SN CPC, and perform ID allocation. The UE performs a random access procedure with the SN (operation 7).

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. Additionally, one or more programs may include instructions for controlling an electronic device to execute the methods according to the embodiments described in the claims or the specification of the disclosure.

Such a program (software module, software) may be stored to a random access memory, a non-volatile memory including a flash memory, a ROM, an electrically erasable programmable ROM (EEPROM), a magnetic disc storage device, a CD-ROM, DVD or other optical storage device, a magnetic cassette, and the like. Alternatively, it may be stored to a memory combining part or all of those recording media. A plurality of memories may be included.

The program may be stored in an attachable storage device accessible via a communication network such as internet, intranet, LAN, wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the embodiments of the disclosure, the components included in the disclosure are expressed in a singular or plural form. The singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

In the drawings for explaining the embodiments of the disclosure, the order of description does not necessarily correspond to the execution order, and the precedence relationship may be changed or may be executed in parallel. Additionally, in the drawings explaining the embodiments of the disclosure, some component may be omitted and only some element may be included therein without departing from the essential spirit and the scope of the disclosure.

The embodiments of the disclosure may be fulfilled by combining some or all of the contents of each embodiment without departing from the essential spirit and the scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving radio resource control (RRC) reconfiguration message including conditional reconfiguration information;
in case that the conditional reconfiguration information is first conditional reconfiguration information related with master cell group (MCG) and the RRC reconfiguration message is received via a signaling radio bearer 1 (SRB1) from a master node (MN), performing a conditional reconfiguration procedure based on first variable related to the MN; and
in case that the conditional reconfiguration information is second conditional reconfiguration information related with secondary cell group (SCG), and the RRC reconfiguration is first RRC reconfiguration message embedded in second RRC reconfiguration message and the second RRC reconfiguration message is received via the SRB1 from the MN or the RRC reconfiguration message is received via a SRB3 from a secondary node (SN), performing the conditional reconfiguration procedure based on second variable related to the SN.

2. The method of claim 1,
wherein the conditional reconfiguration information includes at least one conditional reconfiguration add/modification information, and
wherein a conditional reconfiguration add/modification information includes at least one of a conditional reconfiguration identification (ID), a condition information related with measurement ID and a conditional RRC configuration.

3. The method of claim 2, further comprising:
in case that the conditional reconfiguration information is the first conditional reconfiguration information and the conditional reconfiguration ID does not exist in the first variable, generating a new entry within the first variable for the conditional reconfiguration ID based on at least one of the condition information and the conditional RRC configuration, or
in case that the conditional reconfiguration information is the first conditional reconfiguration information and the conditional reconfiguration ID exists in the first variable, modifying an entry corresponding to the conditional reconfiguration ID based on at least one of the condition information and the conditional RRC configuration.

4. The method of claim 2, further comprising:
in case that the conditional reconfiguration information is the second conditional reconfiguration information and the conditional reconfiguration ID does not exist in the second variable, generating a new entry within the second variable for the conditional reconfiguration ID based on at least one of the condition information and the conditional RRC configuration, or
in case that the conditional reconfiguration information is the second conditional reconfiguration information and the conditional reconfiguration ID exists in the second variable, modifying an entry corresponding to the conditional reconfiguration ID based on at least one of the condition information and the conditional RRC configuration.

5. The method of claim 1,
wherein the conditional reconfiguration information includes at least one conditional reconfiguration release information, and
wherein a conditional reconfiguration release information includes a conditional reconfiguration identification (ID).

6. The method of claim 5, further comprising:
in case that the conditional reconfiguration information is first conditional reconfiguration information, releasing an entry corresponding to the conditional reconfiguration ID from the first variable.

7. The method of claim 5, further comprising:
in case that the conditional reconfiguration information is second conditional reconfiguration information, releasing an entry corresponding to the conditional reconfiguration ID from the second variable.

8. The method of claim 1,
wherein first measurement ID related with a condition information in the first variable refers to a measurement ID in an MCG measurement configuration, and
wherein second measurement ID related with a condition information in the second variable refers to a measurement ID in a SCG measurement configuration.

9. The method of claim 1, further comprising:
in case that the conditional reconfiguration procedure is succeeded, releasing all entries within the first variable and the second variable.

10. A user equipment (UE) in a wireless communication system, the UE comprising:
a transceiver; and
at least one controller operably coupled to the transceiver, the at least one controller configured to:
receive radio resource control (RRC) reconfiguration message including conditional reconfiguration information,
in case that the conditional reconfiguration information is first conditional reconfiguration information related with master cell group (MCG) and the RRC reconfiguration message is received via a signaling radio bearer 1 (SRB1) from a master node (MN), perform a conditional reconfiguration procedure based on first variable related to the MN, and
in case that the conditional reconfiguration information is second conditional reconfiguration information related with secondary cell group (SCG), and the RRC reconfiguration is first RRC reconfiguration message embedded in second RRC reconfiguration message and the second RRC reconfiguration message is received via the SRB1 from the MN or the RRC reconfiguration message is received via a SRB3 from a secondary node (SN), perform the conditional reconfiguration procedure based on second variable related to the SN.

11. The UE of claim 10,
wherein the conditional reconfiguration information includes at least one conditional reconfiguration add/modification information, and
wherein a conditional reconfiguration add/modification information includes at least one of a conditional reconfiguration identification (ID), a condition information related with measurement ID and a conditional RRC configuration.

12. The UE of claim 11, the at least one controller is further configured to:
in case that the conditional reconfiguration information is the first conditional reconfiguration information and the conditional reconfiguration ID does not exist in the first variable, generate a new entry within the first variable for the conditional reconfiguration ID based on at least one of the condition information and the conditional RRC configuration, or
in case that the conditional reconfiguration information is the first conditional reconfiguration information and the conditional reconfiguration ID exists in the first variable, modify an entry corresponding to the conditional reconfiguration ID based on at least one of the condition information and the conditional RRC configuration.

13. The UE of claim 11, the at least one controller is further configured to:
in case that the conditional reconfiguration information is the second conditional reconfiguration information and the conditional reconfiguration ID does not exist in the second variable, generate a new entry within the second variable for the conditional reconfiguration ID based on at least one of the condition information and the conditional RRC configuration, or
in case that the conditional reconfiguration information is the second conditional reconfiguration information and the conditional reconfiguration ID exists in the second variable, modify an entry corresponding to the conditional reconfiguration ID based on at least one of the condition information and the conditional RRC configuration.

14. The UE of claim 10,
wherein the conditional reconfiguration information includes at least one conditional reconfiguration release information, and
wherein a conditional reconfiguration release information includes a conditional reconfiguration identification (ID).

15. The UE of claim 14, the at least one controller is further configured to:
in case that the conditional reconfiguration information is first conditional reconfiguration information, release an entry corresponding to the conditional reconfiguration ID from the first variable.

16. The UE of claim 14, the at least one controller is further configured to:
in case that the conditional reconfiguration information is second conditional reconfiguration information, release an entry corresponding to the conditional reconfiguration ID from the second variable.

17. The UE of claim 10,
wherein first measurement ID related with a condition information in the first variable refers to a measurement ID in an MCG measurement configuration, and
wherein second measurement ID related with a condition information in the second variable refers to a measurement ID in a SCG measurement configuration.

18. The UE of claim 10, the at least one controller is further configured to:
in case that the conditional reconfiguration procedure is succeeded, release all entries within the first variable and the second variable.
